(19) United States
(12) Patent Application Publication
(10) Pub. No.: US 2014/0052643 A1
(43) Pub. Date: Feb. 20, 2014

(54) MANAGING MULTIPLE APPROVALS FOR PROJECTS

(71) Applicants: Nicholas A. Baldwin, Gladesville (AU); Mark C. Hampton, Carlton (AU); Stefan A. Hepper, San Jose, CA (US); Eric Martinez de Morentin, Manly (AU)

(72) Inventors: Nicholas A. Baldwin, Gladesville (AU); Mark C. Hampton, Carlton (AU); Stefan A. Hepper, San Jose, CA (US); Eric Martinez de Morentin, Manly (AU)

(73) Assignee: International Business Machines Corporation, Armonk, NY (US)

(21) Appl. No.: 13/586,164

(22) Filed: Aug. 15, 2012

(51) Int. Cl. G06Q 10/06

(52) U.S. Cl. 705/301

(57) ABSTRACT

A method, computer program product, and system for management of multiple approvals is described. A project is identified, the project including one or more items and having an associated project workflow requiring approval of one or more portions of the project by one or more approvers. An update to a project item is identified. An approver is identified, wherein approval by the approver of one or more of the item and an update to the item is required by the project workflow. The approver is associated with the project based upon, at least in part, the approval by the approver of one or more of the item and the update to the item being required by the project workflow. An order of approval for the project is determined based upon, at least in part, identifying the approver and the update to the item.

### TECHNICAL FIELD

This disclosure relates to approving portions of projects.

### BACKGROUND

Multiple users may sometimes collaborate on projects containing multiple items, such as documents, presentations, multimedia files, and so on. Particularly in business settings, but also in other settings as well, completion of certain stages of such projects (sometimes including updates to project items) may be marked by approval of one or more portions of the project by one or more users or administrators. In some instances, approval of one set of approvers may be required, for a given portion of a project, before approval may be obtained from a different set of approvers.

### BRIEF SUMMARY OF THE DISCLOSURE

According to a first aspect of the disclosure, a computer-implemented method includes identifying, by one or more computing devices, a project, the project including one or more items and having an associated project workflow requiring approval of one or more portions of the project by one or more approvers. The method further includes identifying, by the one or more computing devices, a first update to a first item included in the project. The method further includes identifying, by the one or more computing devices, a first approver, wherein approval by the first approver of one or more of the first item and the first update to the first item is required by the project workflow. The method further includes associating, by the one or more computing devices, the first approver with the project based upon, at least in part, the approval by the first approver of one or more of the first item and the first update to the first item being required by the project workflow. The method further includes determining, by the one or more computing devices, an order of approval for the project based upon, at least in part, identifying the first approver and identifying the first update to the first item.

One or more of the following features may be included. The method may include identifying, by the one or more computing devices, an addition of a second item to the project. The method may further include identifying, by the one or more computing devices, a second approver, wherein approval by the second approver of one or more of the second item and a second update to the second item is required by the project workflow. The method may further include associating, by the one or more computing devices, the second approver with the project based upon, at least in part, the approval by the second approver of one or more of the second item and the second update to the second item being required by the project workflow. Determining the order of approval for the project may be further based upon, at least in part, associating the second approver with the project.

The method may further include identifying, by the one or more computing devices, an association of a third approver with the project, wherein approval by the third approver of a third item included in the project is required by the project workflow. The method may further include identifying, by the one or more computing devices, removal of the third item from the project. The method may further include determining, by the one or more computing devices, that the third approver is not associated with the approval of any item included in the project, other than the third item. The method may further include removing, by the one or more computing devices, the association of the third approver with the project based upon, at least in part, at least one of identifying the removal of the third item from the project and determining that the third approver is not associated with approval of any item included in the project, other than the third item. Determining the order of approval for the project may be further based upon, at least in part, removing the association of the third approver with the project.

Determining the order of approval for the project may further include determining, by the one or more computing devices, a first tier of approval and a second tier of approval. Determining the order of approval for the project may further include identifying, by the one or more computing devices, an association of a duplicate approver with the first tier of approval and the second tier of approval. Determining the order of approval for the project may further include removing, by the one or more computing devices, the association of the duplicate approver with the first tier of approval. Determining the order of approval for the project may further include associating with the second tier of approval, by the one or more computing devices, all approvals associated with the duplicate approver.

The method may further include determining, by the one or more computing devices, a first tier of approval and a second tier of approval. The method may further include identifying, by the one or more computing devices, an association of a duplicate approver with the first tier of approval and the second tier of approval. The method may further include removing, by the one or more computing devices, the association of the duplicate approver with the second tier of approval. The method may further include associating with the first tier of approval, by the one or more computing devices, all approvals associated with the duplicate approver.

A duplicate approver may be associated with a secondary approval, the secondary approval depending from one or more primary approvals. The determined order of approval may include obtaining the secondary approval from the duplicate approver after obtaining the one or more primary approvals. The method may further include obtaining, by the one or more computing devices, all approvals associated with the duplicate approver after obtaining each other approval associated with the first tier of approval.

According to another aspect of the disclosure, a computer program product resides on a computer readable storage medium and has a plurality of instructions stored on it. When executed by a processor, the instructions cause the processor to perform operations including identifying a project, the project including one or more items and having an associated project workflow requiring approval of one or more portions of the project by one or more approvers. The operations further include identifying a first update to a first item included in the project. The operations further include identifying a first approver, wherein approval by the first approver of one or more of the first item and the first update to the first item is required by the project workflow. The operations further include associating the first approver with the project based upon, at least in part, the approval by the first approver of one or more of the first item and the first update to the first item being required by the project workflow. The operations further include determining an order of approval for the project based upon, at least in part, identifying the first approver and identifying the first update to the first item.

One or more of the following features may be included. The plurality of instructions, when executed by the processor, may cause the processor to perform operations including identifying an addition of a second item to the project. The operations may further include identifying a second approver, wherein approval by the second approver of one or more of the second item and a second update to the second item is required by the project workflow. The operations may further include associating the second approver with the project based upon, at least in part, the approval by the second approver of one or more of the second item and the second update to the second item being required by the project workflow. Determining the order of approval for the project may be further based upon, at least in part, associating the second approver with the project.

The operations may further include identifying an association of a third approver with the project, wherein approval by the third approver of a third item included in the project is required by the project workflow. The operations may further include identifying removal of the third item from the project. The operations may further include determining that the third approver is not associated with any item included in the project, other than the third item. The operations may further include removing the association of the third approver with the project based upon, at least in part, at least one of identifying the removal of the third item from the project and determining that the third approver is not associated with any item included in the project, other than the third item. Determining the order of approval for the project may be further based upon, at least in part, removing the association of the third approver with the project.

Determining the order of approval for the project may include determining a first tier of approval and a second tier of approval. Determining the order of approval for the project may further include identifying an association of a duplicate approver with the first tier of approval and the second tier of approval. Determining the order of approval for the project may further include removing the association of the duplicate approver with the first tier of approval. Determining the order of approval for the project may further include associating with the second tier of approval all approvals associated with the duplicate approver.

The operations may further include determining a first tier of approval and a second tier of approval. The operations may further include identifying an association of a duplicate approver with the first tier of approval and the second tier of approval. The operations may further include removing the association of the duplicate approver with the second tier of approval. The operations may further include associating with the first tier of approval all approvals associated with the duplicate approver.

A duplicate approver may be associated with a secondary approval, the secondary approval depending from one or more primary approvals. The determined order of approval may include obtaining the secondary approval from the duplicate approver after obtaining the one or more primary approvals. The operations may further include obtaining, by the one or more computing devices, all approvals associated with the duplicate approver after obtaining each other approval associated with the first tier of approval.

According to another aspect of the disclosure, a computing system includes at least one processor and at least one memory architecture coupled with the at least one processor. The computing system also includes a first software module executable by the at least one processor and the at least one memory architecture, wherein the first software module is configured to identify a project, the project including one or more items and having an associated project workflow requiring approval of one or more portions of the project by one or more approvers. The computing system also includes a second software module executable by the at least one processor and the at least one memory architecture, wherein the second software module is configured to identify a first update to a first item included in the project. The computing system also includes a third software module executable by the at least one processor and the at least one memory architecture, wherein the third software module is configured to identify a first approver, wherein approval by the first approver of one or more of the first item and the first update to the first item is required by the project workflow. The computing system also includes a fourth software module executable by the at least one processor and the at least one memory architecture, wherein the fourth software module is configured to associate the first approver with the project based upon, at least in part, the approval by the first approver of one or more of the first item and the first update to the first item being required by the project workflow. The computing system also includes a fifth software module executable by the at least one processor and the at least one memory architecture, wherein the fifth software module is configured to determine an order of approval for the project based upon, at least in part, identifying the first approver and identifying the first update to the first item.

One or more of the following features may be included. The computing system may include an sixth software module executable by the at least one processor and the at least one memory architecture, wherein the sixth software module is configured to identify an addition of a second item to the project. The computing system may include a seventh software module executable by the at least one processor and the at least one memory architecture, wherein the seventh software module is configured to identify a second approver, wherein approval by the second approver of one or more of the second item and a second update to the second item is required by the project workflow. The computing system may include an eighth software module executable by the at least one processor and the at least one memory architecture, wherein the eighth software module is configured to associate the second approver with the project based upon, at least in part, the approval by the second approver of one or more of the second item and the second update to the second item being required by the project workflow. Determining the order of approval for the project may be further based upon, at least in part, associating the second approver with the project.

The computing system may also include a ninth software module executable by the at least one processor and the at least one memory architecture, wherein the ninth software module is configured to identify an association of a third approver with the project, wherein approval by the third approver of a third item included in the project is required by the project workflow. The computing system may also include a tenth software module executable by the at least one processor and the at least one memory architecture, wherein the tenth software module is configured to identify the removal of the third item from the project. The computing system may also include a eleventh software module executable by the at least one processor and the at least one memory architecture, wherein the eleventh software module is configured to determine that the third approver is not associated with any item included in the project, other than the third item. The computing system may also include a twelfth software module executable by the at least one processor and the at least one memory architecture, wherein the twelfth software module is configured to remove the association of the third approver with the project based upon, at least in part, at least one of identifying the removal of the third item from the project and determining that the third approver is not associated with any item included in the project, other than the third item. Determining the order of approval for the project may be further based upon, at least in part, removing the association of the third approver with the project.

Determining the order of approval for the project may include determining a first tier of approval and a second tier of approval. Determining the order of approval for the project may further include identifying an association of a duplicate approver with the first tier of approval and the second tier of approval. Determining the order of approval for the project may further include removing the association of the duplicate approver with the first tier of approval. Determining the order of approval for the project may further include associating with the second tier of approval all approvals associated with the duplicate approver.

The computing system may further include a thirteenth software module executable by the at least one processor and the at least one memory architecture, wherein the thirteenth software module is configured to determine a first tier of approval and a second tier of approval. The computing system may further include a fourteenth software module executable by the at least one processor and the at least one memory architecture, wherein the fourteenth software module is configured to identify an association of a duplicate approver with the first tier of approval and the second tier of approval. The computing system may further include a fifteenth software module executable by the at least one processor and the at least one memory architecture, wherein the fifteenth software module is configured to remove the association of the duplicate approver with the second tier of approval. The computing system may further include a sixteenth software module executable by the at least one processor and the at least one memory architecture, wherein the sixteenth software module is configured to associate with the first tier of approval all approvals associated with the duplicate approval.

A duplicate approver may be associated with a secondary approval, the secondary approval depending from one or more primary approvals. The determined order of approval may include obtaining the secondary approval from the duplicate approver after obtaining the one or more primary approvals. The computing system may further include a seventeenth software module executable by the at least one processor and the at least one memory architecture, wherein the seventeenth software module is configured to obtaining, by the one or more computing devices, all approvals associated with the duplicate approver after obtaining each other approval associated with the first tier of approval.

According to another aspect of the disclosure, a computer-implemented method includes identifying, by one or more computing devices, a project, the project including one or more items and having an associated project workflow requiring approval of one or more portions of the project by one or more approvers. The method further includes identifying, by the one or more computing devices, a first update to a first item included in the project. The method further includes identifying, by the one or more computing devices, a first approver, wherein approval by the first approver of one or more of the first item and the first update to the first item is required by the project workflow. The method further includes associating, by the one or more computing devices, the first approver with the project based upon, at least in part, the approval by the first approver of one or more of the first item and the first update to the first item being required by the project workflow.

The method further includes identifying, by the one or more computing devices, an addition of a second item to the project. The method further includes identifying, by the one or more computing devices, a second approver, wherein approval by the second approver of one or more of the second item and a second update to the second item is required by the project workflow. The method further includes associating, by the one or more computing devices, the second approver with the project based upon, at least in part, the approval by the second approver of one or more of the second item and the second update to the second item being required by the project workflow.

The method further includes determining, by the one or more computing devices, an order of approval for the project based upon, at least in part, identifying the first approver and associating the second approver with the project.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a approval management process coupled to a distributed computing network;

FIG. 2 is a first flowchart of a process executed by the approval management process of FIG. 1;

FIG. 3 is a second flowchart of a process executed by the approval management process of FIG. 1;

FIG. 4 is a diagrammatic view of an aspect of an implementation of the approval management process of FIG. 1.;

FIG. 5 is a diagrammatic view of another aspect of an implementation of the approval management process of FIG. 1.;

FIG. 6 is a diagrammatic view of another aspect of an implementation of the approval management process of FIG. 1.;

Like reference symbols in the various drawings indicate like elements.

### DETAILED DESCRIPTION OF THE PREFERRED EMBODIMENTS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer usable medium may be a computer readable signal medium or a computer readable storage medium. A computer-usable, or computer-readable, storage medium (including a storage device associated with a computing device or client electronic device) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

In business (and other) endeavors, multiple individuals may sometimes collaborate on projects containing multiple items. For example, one or more business teams may work together to create a project such as a business plan, which may include presentation materials, memoranda, letters, prospectuses, multi-media materials such as videos, spreadsheets and other items. Various items included in a project may be linked to or associated with other items in complex ways or may be associated with other items only inasmuch as each of the items are associated with the project. For example, a letter in a project may incorporate active links to a spreadsheet or a presentation including a link to a video, while a different letter may reference other project items but not contain active associations with those items beyond a common association with the larger project.

As part of the development and refinement of a project, it will be understood that items may be edited (i.e., updated) by various project participants (or others) and/or may be added to or removed from the project. For example, a spreadsheet may undergo multiple revisions to ensure that its calculations are accurate and effectively presented, a cover letter may be added to the project in order to provide a summary of other project items, or presentation materials may be removed from a project because their content is deemed to no longer be relevant or appropriate for the project. It will be understood that these examples (and others throughout the disclosure) are not exhaustive, and that various other instances of updating, adding, or removing items may be possible.

In order to ensure that the final project (and all the items in it) is acceptable, it may be desirable to obtain approval of updates, additions, or removals of items associated with the project. In certain instances, approval of items may be relatively simple. For example, in a simple project a single project coordinator may be responsible for approving any updates to any associated items. In other instances, for example when a project includes a substantial number of items, participants, and/or approvers, managing an approval process may be more complex. For example, a project with 100 items, each of which is subject to updating (and/or addition to or removal from the project), may variously require approval from dozens of approvers, including supervisors, managers, subject matter experts, and so on. Further, updates to certain items may require approval by one or more approvers and in a certain order. For example, an update to a critical presentation may need to be approved by the immediate supervisor of the participant implementing the update, as well as the manager of the supervisor and the overseer of the entire project. Management of this flow of approval may be complicated, as approval requirements may sometimes overlap and the timing of approval may be important. For example, continuing the discussion above, it may be inappropriate or inefficient to obtain approval from the overseer of the project before obtaining approval from approvers lower in the project hierarchy—e.g., the manager and the supervisor. Further, it may be more efficient to obtain at one time approval from a given approver for all items that have been updated and that require approval by that approver, than to obtain approval for each of those items at different times. An Approval Management (“AM”) process may be useful in these and other respects.

In the illustrative embodiments herein, much of the discussion of this disclosure will focus explicitly on approval of updates to items. It will be understood aspects of an AM process regarding approval of updates, as discussed throughout the disclosure, may also be appropriate for approval of adding items to or removing items from a project. It will be further understood that reference to approval of an item may encompass general approval of an item (e.g., for publication as part of the final project product) as well as approval or one or more updates to the item and/or addition or removal of an item.

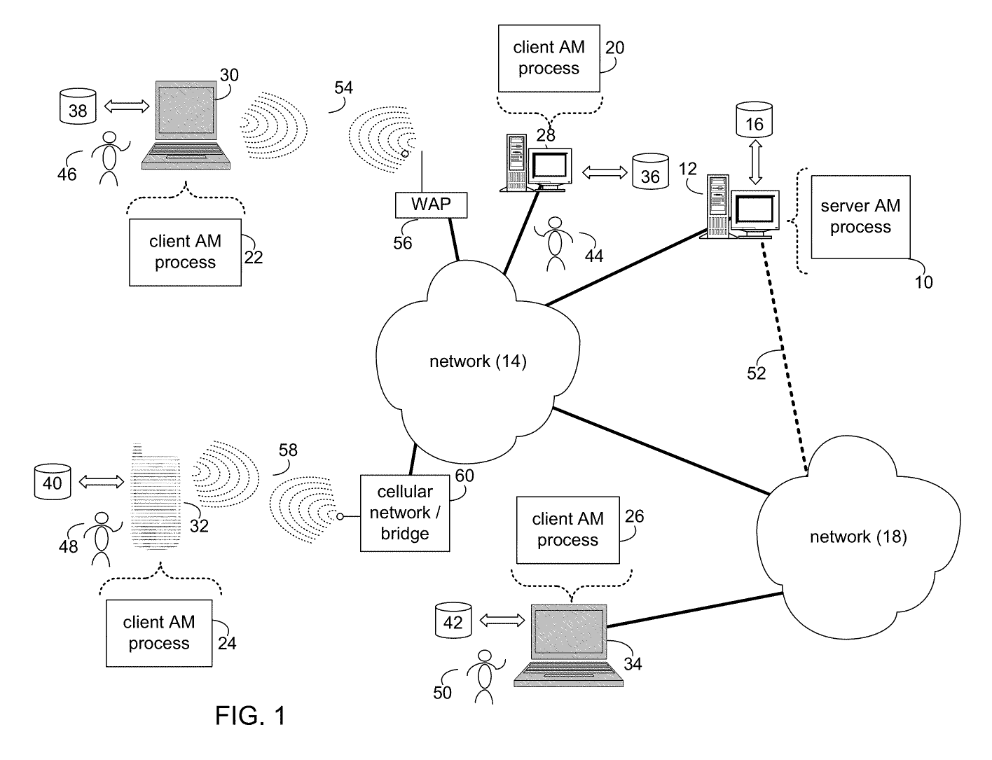

Referring now to FIG. 1, an AM process may be coupled to a computer or computer network. For example, server AM process 10 may reside on and may be executed by server computer 12, which may be connected to network 14 (e.g., the Internet or a local area network). Examples of server computer 12 may include, but are not limited to: a personal computer, a server computer, a series of server computers, a mini computer, and/or a mainframe computer. Server computer 12 may be a web server (or a series of servers) running a network operating system, examples of which may include but are not limited to: Microsoft® Windows Server®; Novell® Netware®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.)

The instruction sets and subroutines of server AM process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft® IIS, Novell® Web Server™, or Apache® Web Server, that allows for access to server computer 12 (via network 14) using one or more protocols, examples of which may include but are not limited to HTTP (i.e., HyperText Transfer Protocol), SIP (i.e., session initiation protocol), and the Lotus® Sametime® VP protocol. (Webserver is a trademark of Novell Corporation in the United States, other countries, or both; Apache is a registered trademarks of Apache Software Foundation in the United States, other countries, or both; Lotus and Sametime are registered trademarks of International Business Machine Corp. in the United States, other countries, or both.) Network 14 may be connected to one or more secondary networks (e.g., network 18), examples of which may include but are not limited to: a local area network; a wide area network; or an intranet, for example.

Client AM processes 20, 22, 24, 26 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 14 and/or network 18 and may each execute an operating system, examples of which may include but are not limited to Microsoft® Windows®, Microsoft Windows CE®, Red Hat® Linux®, or a custom operating system.

The instruction sets and subroutines of client AM processes 20, 22, 24, 26, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Users 44, 46, 48, 50 may access an AM process in various ways. For example, these users may access server AM process 10 directly through the device on which a client process (e.g., client AM processes 20, 22, 24, 26) is executed, namely client electronic devices 28, 30, 32, 34. Users 44, 46, 48, 50 may access server AM process 10 directly through network 14 and/or through secondary network 18. Further, server computer 12 (i.e., the computer that executes server AM process 10) may be connected to network 14 through secondary network 18, as illustrated with phantom link line 52. Users 44, 46, 48, 50 may also access a GUI-generating application in similar ways.

The various client electronic devices may be directly or indirectly coupled to network 14 (or network 18). For example, personal computer 28 is shown directly coupled to network 14 via a hardwired network connection. Further, notebook computer 34 is shown directly coupled to secondary network 18 via a hardwired network connection. Laptop computer 30 is shown wirelessly coupled to network 14 via wireless communication channel 54 established between laptop computer 30 and wireless access point (i.e., WAP) 56, which is shown directly coupled to network 14. WAP 56 may be, for example, an IEEE 802.11a, 802.11b, 802.11g, 802.11n, Wi-Fi, and/or Bluetooth device that is capable of establishing wireless communication channel 54 between laptop computer 30 and WAP 56. Data-enabled mobile telephone 32 is shown wirelessly coupled to network 14 via wireless communication channel 58 established between data-enabled mobile telephone 32 and cellular network/bridge 60, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

For the following discussion, client AM process 20 will be described for illustrative purposes. It will be understood that client AM process 20 may, for example, interact and/or communicate with server AM process 10 and/or may be executed within one or more applications that allow for communication with other server and/or client AM processes. This is not intended to be a limitation of this disclosure, as other configurations are possible (e.g., AM process 20 may include stand-alone client processes and/or stand-alone server processes.) For example, some implementations may include one or more of client AM processes 22, 24, 26 or server AM process 10 in place of or in addition to client AM process 20.

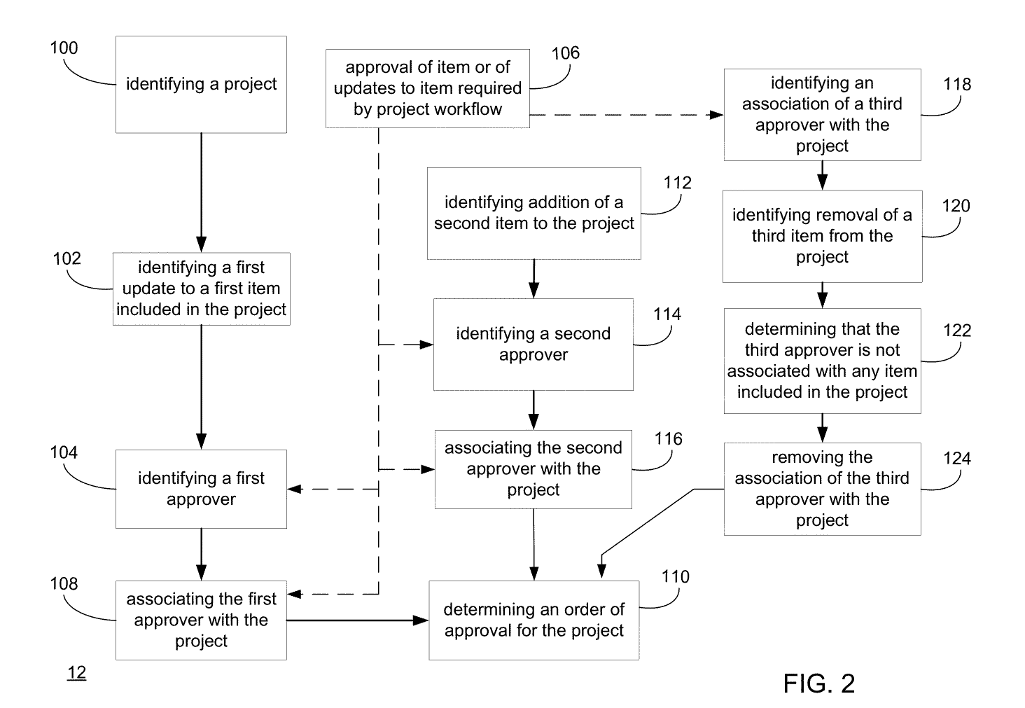

Referring now also to FIG. 2, there is shown a diagrammatic view of a process implemented by a AM process, e.g., client AM process 20. An AM process may identify 100 a project, the project including one or more items and having an associated project workflow requiring approval of one or more portions of the project by one or more approvers. An AM process may further identify 102 a first update to a first item included in the project. An AM process may further identify 104 a first approver, wherein approval by the first approver of one or more of the first item and the first update to the first item is required by the project workflow. An AM process may further include associating 108 the first approver with the project based upon, at least in part, the approval by the first approver of one or more of the first item and the first update to the first item being required by the project workflow. An AM process may further include determining 110 an order of approval for the project based upon, at least in part, identifying the first approver and identifying the first update to the first item.

Client AM process 20 may identify 100 a project, wherein the project includes one or more items and wherein a project workflow requires approval of one or more portions of the project by one or more approvers. As discussed in part above, a project may be a collaboration between multiple individuals in a business or other setting. In order to achieve business of other goals, multiple items may be associated with a project, including word processing documents, presentation materials, multi-media materials, web pages, emails, transcripts, spreadsheets, electronic folders, and so on. In this way, a project may represent a collection of items sharing one or more common aspects, such as subject matter or purpose.

In order to manage the contents and development of a project, a workflow may be associated with the project. A workflow may be implemented and associated with a project using a variety of means, including through association of an electronic record (not shown) with the project. For example, a workflow may be implemented and associated with a project using commercial products such as IBM WebSphere® MQ Workflow, IBM Lotus® Workflow™ or other commercial products. (WebSphere is a registered trademark and Workflow is a trademark of International Business Machine Corp. in the United States, other countries, or both.) A workflow may specify various information related to the project including the items and individuals associated with the project, and may represent this information with various levels of granularity. For example, a workflow may include information relating to the authors and/or contributors to one or more items, and deadlines associated with various items or the project as a whole. A workflow may further include information associating approvers with various items also associated with the project. For example, when an item is created or associated with the project, a project participant (or another individual or moderator) may specify that updates to that item need to be approved by one or more individuals.

AM process 20 may further identify 102 a first update to a first item included in the project. As also discussed above, a project may include one or more items, which may include a wide variety of electronic and other document types. In order to manage the approval process, AM process 20 may accordingly identify one or more specific items included in the project. AM process 20 may identify an item included in a project by reference to a project workflow or by other means. As also discussed above, as a project progresses toward completion, participants in the product may implement one or more updates with respect to one or more items included in the project, including, for example, editing the content of the various items. AM process 20 may identify 102 an update in a variety of ways. For example, AM process 20 may actively or intermittently monitor an identified 102 item in order to determine whether an update has occurred with respect to that item. Alternatively, a participant—i.e., the participant responsible for implementing an update or another participant associated with the project—or a project workflow may actively indicate that an item has been updated. For example, a participant may provide an input to (or associated with) the project workflow indicating that an update has been implemented and, accordingly, that approval may be required or a project workflow may provide an indication of the same.

AM process 20 may further identify 104 a first approver, wherein approval by the first approver of the first item or of the first update to the first item may be required 106 by a project workflow. AM process may identify 104 an approver in a variety of ways. For example, upon identifying 102 an update, AM process may refer to the project workflow to determine whether one or more approvers are associated by the workflow with the updated item. In another embodiment, a participant or moderator may indicate directly to AM process 20 that a particular approver is associated with a particular item. It will be understood that an approver may be associated by the workflow (or otherwise) with an item and/or with a specific type of update to an item. For example, the approval of one particular individual may be required for updates to a “financial calculations” portion of a project memorandum whereas the approval of a different individual may be required for updates to a “business objectives” portion of a project memorandum, and so on. As such, AM process 20 may identify 104 an approver based upon an item being updated as well as the type of update (and the type of item).

AM process 20 may further associate 108 the first approver with the project. In certain embodiments, associating 108 an approver with a project may result through reference to a project workflow, which may specify that approval by a certain individual (or individuals) is required for any updates to a particular item (or for a particular type of update to a particular item). In another embodiment, a participant or moderator may indicate directly to AM process 20 that a particular approver is associated with a project, in some cases based upon the approver being associated with a particular item or update. As such, associating 108 an approver with a project may be based upon the project workflow requiring 106 approval by the first approver of the first item or of the first update to the first item, or upon other factors.

AM process 20 may further determine 110 an order of approval for the project. Continuing the examples above, in certain projects the multitude of approvals, including approval of certain updates by multiple individuals in particular order, may introduce complexity into the approval process. Similarly, the approval process may be complicated by, for example, an order of approval specified by the a project workflow (or otherwise) for a particular item. For example, in certain instances a project workflow may specify that a particular item may only be approved after a different item has been approved by all required approvers. As another example, a project workflow may specify that all subject matter experts must give approval for updates and/or items before approval is requested from business managers. In light of these and other considerations, certain orders of approval may be more efficient than or otherwise preferable to others. For example, it may be more efficient to obtain all approvals associated with a particular level in an organizational hierarchy (e.g., group supervisors) before obtaining approvals associated with a more senior level in the organizational hierarchy (e.g., section managers). Accordingly, AM process 20 may obtain approval from all (or some) approvers in certain organizational hierarchy levels before obtaining approval from all (or some) approvers in other organizational hierarchy levels. As another example, it may be desirable to avoid, if possible, requesting approval from a single approval on multiple separate occasions. As such, it may be desirable to request approval from the approver for all items/updates with which she is associated at one time. Accordingly, AM process 20 may determine that approval of updates to multiple items may be required from a particular approver and may accordingly reserve requests for approval from that approver until each of those items has been updated and submitted for approval.

In general, determining 110 an order of approval may occur through the application of a variety of rule-based analysis, which may take into account, among other factors, organizational hierarchies, the types of items being updated, the types of updates implemented, deadlines for updates and/or approval of various items, the requirement that multiple approvers approve certain items, that requirement that an approver approve multiple items, the subject matter of the items and/or updates, and so on. Rules may be determined based upon input from project administrators or other administrators, organizational logic, artificial intelligence analysis, data mining of past workflow and approval management to determine successful and unsuccessful strategies, and so on. Once an order of approval has been determined 110, AM process 20 may further implement the order of approval. For example, AM process 20 may (alone or in combination with other process and applications, such as a workflow management application, not shown), request and/or obtain approval from approvers associated with a project in an order reflecting the order of approval.

It will be understood that determining 110 an order of approval may depend on the particular needs of an organization, a project, a set of approvers, or other factors. For example, certain organizations or projects may desire an approval process in which all approvals are obtained as quickly as possible or in which approval from all (or a subset) of the associated approvers are obtained using a minimum number of approval requests. Similarly, the relationship among items and/or approvers may form part of determining 110 an order. Accordingly, determining 110 an order may be situation- and/or organization-specific.

It will be further understood that approval may be requested and/or obtained from approvers in a variety of ways. For example, AM process 20 (or another process) may request and/or obtain approval by email or other electronic communication (e.g., an approver receives and/or sends an email with a specific subject or other content indicating approval and/or a request for approval of one or more items or updates), through action buttons (e.g., an approver is presented with an action button embedded in a project item or workflow management interface and requesting approval of one or more items or updates and uses a mouse or other input device to activate an action button embedded in a project item or workflow management interface to indicate approval of the one or more items or updates), or through other means. (Within this disclosure, references to a request for approval may be viewed as including a reference to obtaining an approval, and vise versa.)

AM process 20 may further identify 112 the addition of a second item to the project. AM process 20 may identify 112 the addition of an item to a project in a variety of ways and may do so directly or indirectly. For example, a project participant or other individual or moderator may provide a notification to AM process 20 that a new item has been added to a project. Alternatively, a process implemented by, for example, a workflow management application may register an addition of an item to a project and accordingly indicate to AM process 20 that the item has been added to the project. It will be understood that in some embodiments the addition of an item to a project may require approval of an approver already associated with the project. In this scenario, the discussion herein of approving updates to items may be applicable to obtaining approval of an item addition.

AM process 20 may further identify 114 a second approver, wherein approval by the second approver of one or more of the second item and a second update to the second item may be required 106 by the project workflow. AM process may identify 114 an approver of an added item in a variety of ways. For example, upon identifying 112 the addition of an item to a project, AM process 20 may refer to the project workflow to determine whether one or more approvers are associated by the workflow with the added item. It will be understood that an approver may be associated by the workflow (or otherwise) with an item and/or with a specific type of update to an item. For example, the approval of one particular individual may be required for updates to a “financial calculations” portion of a project memorandum whereas the approval of a different individual may be required for updates to a “business objectives” portion of a project memorandum, and so on. As such, AM process 20 may identify 114 an approver based upon an item being added as well as the type of updates that are possible for the added item (and the type of item).

AM process 20 may further include associating 116 the second approver with the project. In one embodiment, AM process may maintain a record of the approvers associated with a project (e.g., in a storage device associated with AM process 20) or may reference a record of approvers maintained by another process (e.g., a process associated with a workflow management process). As will be understood from the discussion of this disclosure, this record of approvals associated with a project, which may contain information related to the items, types of items, updates, and/or types of updates with which a particular approver is associated, may be useful to determining 110 an order of approval for a project. AM process 20 may associate 116 an approver associated with an added item by, for example, associating the approver with a record of approvers associated with a project or by determining that the approver has been added by another process or application to a record of approvers associated with the project. Associating 116 the second approver with the project may be based upon approval by the second approver of one or more of the second item and the second update to the second item being required 106 by the project workflow.

It will be understood that an approver may be associated 116 with a project even if the individual representing the approver is already associated with the project as, for example, an author/updater of items. For example, an individual may be associated with a project based on that individual being responsible for authoring various project items as well as updating various other items, but may not be associated with the project as an approver of any item. Accordingly, although the individual may be associated with the project as an author/updater, she may subsequently be associated 116 as an approver if an item is added to the project for which the individual is an approver.

Determining 110 an order of approval for a project may be based upon associating 116 an approver with a project. As will be apparent from this disclosure, determining) 10 an order of approval for a project may depend in part on the specific approvers and items associated with a project. Accordingly, AM process 20 may determine 110 an order of approval, at least in part, based on identifying 114 an approver and based on identifying 112 the addition of an item to a project. (It will be understood that a project, when first created, may not include any items. Accordingly, a list of associated approvers and an order of approval may be determined based on the initial association of one or more items with the newly-created project.)

AM process 20 may further identify 118 an association of a third approver with a project, wherein approval by the third approver of a third item included in the project and/or a third update to the third item is required 106 by the project workflow. As also discussed above, AM process may identify 118 an approver in a variety of ways. For example, upon identifying an item (or update to an item), AM process may refer to the project workflow to determine whether one or more approvers are associated by the workflow with the item (or item update). In another embodiment, a participant or moderator may indicate directly to AM process 20 that a particular approver is associated with a project, in some cases based upon the approver being associated with a particular item or update. It will be understood that an approver may be associated by the workflow (or otherwise) with an item and/or with a specific type of update to an item. For example, the approval of one particular individual may be required for updates to a “financial calculations” portion of a project memorandum whereas the approval of a different individual may be required for updates to a “business objectives” portion of a project memorandum, and so on. As such, AM process 20 may identify 118 an approver based upon identifying an item or upon an item being updated, as well as the type of update (and the type of item).

AM process 20 may further identify 120 removal of the third item from the project. As a project progresses, items may be removed from the project as well as added to it. AM process 20 may identify 120 the removal of an item from a project in a variety of ways and may do so directly or indirectly. For example, a project participant or other individual or moderator may provide a notification to AM process 20 that an item has been removed from a project. Alternatively, a process implemented by, for example, a workflow management application may register the removal of an item from a project and accordingly may indicate to AM process 20 that the item has been removed from the project. It will be understood that in some embodiments the removal of an item from a project may require approval of an approver already associated with the project. In this scenario, the discussion herein of approving updates to items may be applicable to obtaining approval of an item removal.

AM process 20 may further determine 122 that the third approver is not associated with any item included in the project, other than the third item and remove 124 the association of the third approver with the project based upon, at least in part, at least one of identifying 120 the removal of the third item from the project and determining 122 that the third approver is not associated with any item included in the project, other than the third item. In one embodiment, AM process 20 may refer to a record of approvers associated with the project and managed or maintained by a project workflow application in order to determine the approvers associated with the project and which items and/or updates those approvers are specifically associated with. If an approver is only associated as an approver with an item that has been removed from a project (i.e., is not associated as an approver with any item that remains included in the project) it may be desirable to ignore that approver when determining 110 an order of approval for the project. Accordingly, it may be useful to determine 122 that an approver is not associated with any item included in a project other than a removed item and to accordingly remove 124 the association of that approver with the project.

It will be understood that removing 124 the association of an approver with a project may include entirely removing an individual from association with a project, or may include only removing the association with the project of the individual as an approver. For example, an approver may be associated as an approver with only one item in a project but may be associated as an author/updater with various other items included in the project. If the first item is removed, but the others remain, the association of the approver with the project as an approver, may be removed although the approver may remain associated with the project as an author/updater of the other items.

Determining 110 the order of approval for the project may be further based upon removing 124 the association of the third approver with the project. As will be apparent from this disclosure, determining 110 an order of approval for a project may depend in part on the specific approvers and items associated with a project. Accordingly, AM process 20 may determine 110 an order of approval based on removing 124 the association of an approver with a project.

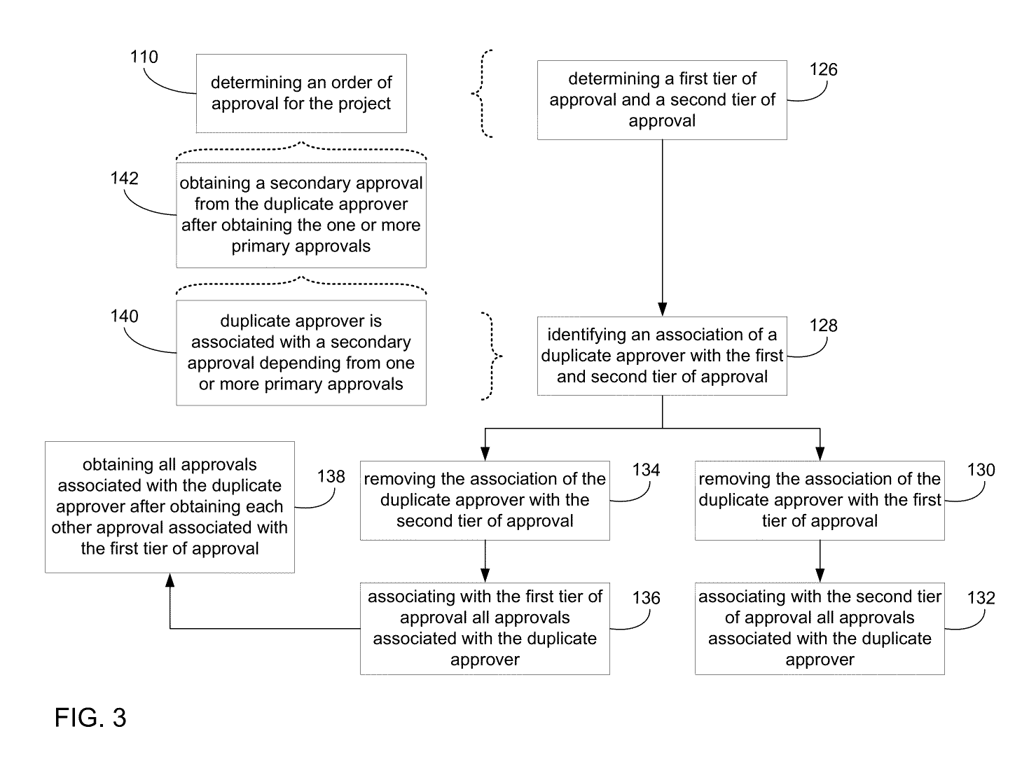

Referring now also to FIG. 3, AM process 20 may further determine 110 an order of approval for the project based upon determining 126 a first tier of approval and a second tier of approval. In certain instances, it may be appropriate to divide approvals into two or more tiers representing, for example, stages of approval. For example, a workflow may require that one or more items be reviewed by multiple approvers and that approval from certain of the approvers (the “primary approvers”) is required before approval from another of the approvers (the “secondary approvers”). As such, in some embodiments, AM process 20 may determine, for example, that approval by the set of primary approvers may be represented as a first tier of approval and that approval by the set of secondary approves may be represented as a second tier of approval. Continuing this example, AM process 20 may determine an order of approval in which, for example, approval should be obtained from all approvers associated with the first tier of approval before approval is obtained from any approver associated with the second tier of approval. Accordingly, AM process 20 may obtain all approvals associated with the first tier of approval before obtaining an approval associated with the second tier of approval.

Tiers of approval may be determined 126 in various ways. For example, in one embodiment, one or more of the first tier of approval and the second tier of approval may be determined 126 based upon identifying all project items that must be approved by all approvers. This may indicate a high priority or importance of these items and that, for example, approval for these items should be sought only after (or before) other less important items or should be sought at the same time (or at nearly the same time). As such, determining 110 an order of approval for a project may include determining, for example, that certain items (or updates to items) included in a project must be approved by all approvers.

In another embodiment, one or more of the first tier of approval and the second tier of approval may be determined 126 based upon identifying all project items that may be approved by any approver. For example, in a given project, it may not matter which approver associated with the project approves a given item (or update to the item), only that the item is approved by one of the associated approvers. Accordingly, it may be efficient to request and/or obtain approval for these items at the same time (or at nearly the same time) or to sequentially request approval from individual approvers among the identified possible approvers in order to avoid wasting the time of all of the possible approvers. For example, an email or other notification may be sent or displayed to some or all of the associated approvers alerting the approvers that certain items require approval and may be approved by any of the associated approvers. In this way, approval may be obtained quickly and efficiently for items for which any approver may provide approval.

AM process 20 may further identify 128 an association of a duplicate approver with the first and second tier of approval. For example, AM process 20 may identify 128 that an approver for a particular project is required by the project workflow to provide approval for one or more items as part of both the first tier and the second tier of approval. For example, an approver may be associated with approval for one project item as part of the first tier of approval and may also be associated with approval for a different project item as part of the second tier of approval. In one embodiment, the approval for the project item as part of the first tier may be a primary approval (i.e., may be an approval that must be obtained before another approver may approve the item). In one embodiment, the approval for the other project item as part of the second tier may be a secondary approval (i.e., may be an approval that cannot be given until another approver has approved the item).

In one embodiment AM process 20 may remove 130 the association of the duplicate approver with the first tier of approval. For example, it may be inefficient to continue to associate an approver with both the first and second tiers of approval because this may result in approval being requested from that approver on multiple occasions. In order to minimize the demand on the approver's time and otherwise optimize the approval process, it may be beneficial to request approval from the approver only once. Accordingly, in addition to removing 130 the association of the duplicate approver with the first tier, AM process may associate 132 with the second tier of approval all approvals associated with the duplicate approver. In this manner, for example, approval may be requested from the duplicate approver only as part of the second tier of approval.

Continuing the example above, if the duplicate approver is associated with both a primary approval associated with the first tier of approval and a secondary approval associated with the second tier of approval, associating 132 all approvals associated with the duplicate approver with the second tier may include associating both the primary and secondary approval with the second tier. Alternatively, associating 132 all the duplicate approver's approvals with the second tier may include removing (and/or replacing) the duplicate approver as an approver responsible for the primary approval associated with the first tier.

In one embodiment, after associating 132 all the duplicate approver's approvals with the second tier, AM process 20 may obtain those approvals from the duplicate approver before obtaining (from other approvers) any other approval associated with the second tier of approval. This may be desirable, for example, if the primary approval associated with the duplicate approver (and, formerly, the first tier of approval) is required before a secondary approval associated with a different approver (and the second tier) may be obtained. In this way, the primary (and secondary) approval from the duplicate approver may be obtained as part of the second tier of approval, but before any dependent approval also associated with the second tier.

In another embodiment AM process 20 may remove 134 the association of the duplicate approver with the second tier of approval. For example, it may be inefficient to continue to associate an approver with both the first and second tiers of approval because this may result in approval being requested from that approver on multiple occasions. In order to minimize the demand on the approver's time and otherwise optimize the approval process, it may be beneficial to request approval from the approver only once. Accordingly, in addition to removing 132 the association of the duplicate approver with the second tier, AM process may associate 136 with the first tier of approval all approvals associated with the duplicate approver. In this manner, for example, approval may be requested from the duplicate approver only as part of the second tier of approval.

Continuing the example above, if the duplicate approver is associated with a primary approval associated with the first tier of approval and a secondary approval associated with the second tier of approval, associating 136 all approvals associated with the duplicate approver with the first tier may include associating both the primary and secondary approval with the first tier. Alternatively, associating 136 all the duplicate approver's approvals with the first tier may include removing (and/or replacing) the duplicate approver as an approver responsible for the secondary approval associated with the second tier.

In one embodiment, after associating 136 all the duplicate approver's approvals with the first tier, AM process 20 may obtain 138 those approvals from the duplicate approver after obtaining (from other approvers) each other approval associated with the first tier of approval. This may be desirable, for example, if a secondary approval associated with the duplicate approver (and, formerly, the second tier of approval) is dependent on a primary approval associated with a different approver (and the first tier of approval). In this way, the secondary (and primary) approval from the duplicate approver may be obtained as part of the first tier of approval, but after any primary approval also associated with the first tier and upon which the duplicate approver's secondary approval may depend.

As also noted above, in one embodiment an approver, including a duplicate approver, may be associated 140 with a secondary approval depending from one or more primary approvals. This may be the case, for example, if updates to an item must be approved by multiple approvers, each with distinct responsibilities within an organizational hierarchy. For example, an update to a financial spreadsheet may require approval from a finance manager (i.e., a primary approval) before it may be approved by a vice president of planning (i.e., a secondary approval). When primary and secondary approvals are associated with a project item, AM process 20 may obtain the secondary approval, including, for example, obtaining 142 a secondary approval from a duplicate approver, after obtaining one or more primary approvals.

As another example, approver X may be required (e.g., by a project workflow) to approve updates to item Q only after approver Y has approved the updates (i.e., as part of a second tier of approval), and may also be required to approve updates to item R before approver Z (i.e., as part of a first tier of approval). In order to avoid a scenario in which the approver X's time is wasted by excessive requests for approval, AM process 20 may obtain 138 approval of approver X for the updates to both items only after obtaining all necessary preceding approvals for those updates—i.e., approval of item Q by approver Y. Alternatively, AM process 20 may determine that another approver may be substituted for approver X with respect to the first tier of approval, i.e., may replace approver X with a different approver with respect to item R. In this manner, approval for item R by approver X may no longer be required as part of the first tier of approval (or at all) or may be required at the end of the first tier of approval (or, alternatively, the beginning of the second tier of approval).

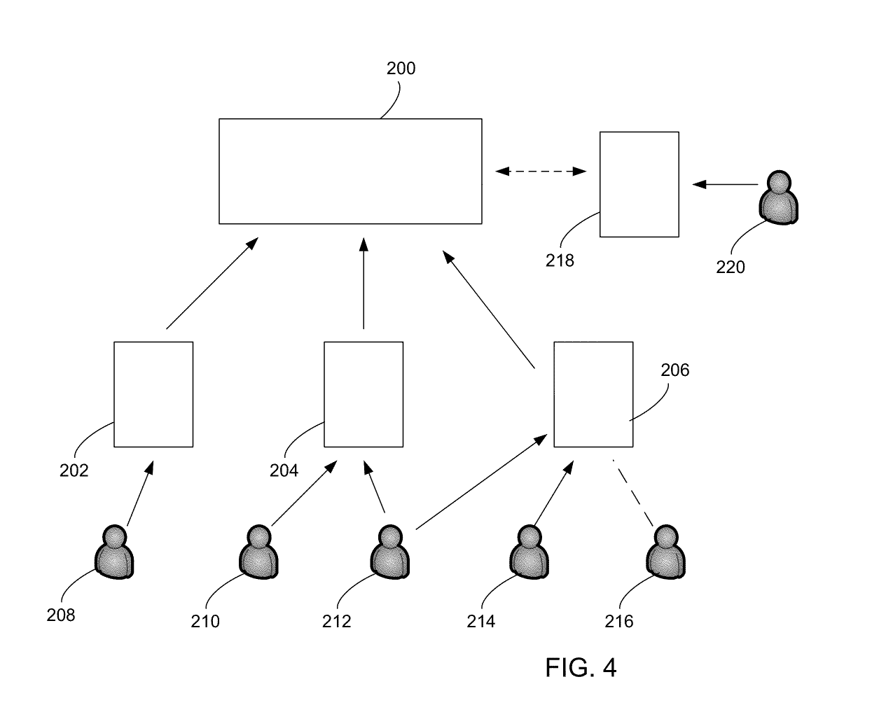

Referring now also to FIG. 4, a project 200 may include item 202, item 204 and item 206. As depicted in FIG. 4, approver 208 may be associated with item 202 (i.e., the approval of approver 208 is required for changes to item 202), as indicated by a solid connecting arrow between the figure elements. Similarly, approvers 210 and 212 may be associated with item 204, and approvers 212 and 214 may be associated with item 206. (It will be understood, as noted above, that a user may be associated with an item without being associated with the item as an approver. For example, user 216 may be the author of item 206 or the author of updates to item 206, but may not necessarily be associated with item 206 as an approver, as indicated by the dotted line between user 216 and item 206 in FIG. 4.)

Still referring to FIG. 4, it will be seen that as the project progresses, item 218 (“item 218”) may be added to or removed from project 200 (as represented by the dashed, double-headed arrow connecting item 218 and project 200), and may be associated with approver 220. As such, AM process 20 may identify 112 the addition of item 218 to (or may identify 120 the removal of item 218 from) the project and accordingly associate 116 (or remove 124 the association of) approver 220 with project 200. AM process 20 may then determine 110 an order of approval fro the project based on associating 116 (or removing 124 the association of) approver 220 with project 200.

In certain embodiments, AM process 20 may determine 126 a first and second tier of approval associated with project 200 and one or more approvers may be associated with a project or a project item as a primary approver or a secondary approver. For example, approval of updates to item 204 may be required from approver 210 after approval for item 204 is obtained from approver 212 (i.e., for item 204, approver 210 is a secondary approver and approver 212 is a primary approver). Similarly, approval by approver 214 for item 206 may be required before approval by approver 212 for item 206 (i.e., for item 206, approver 214 is a primary approver and approver 212 is a secondary approver). As such, AM process 20 may identify 128 an association of approver 212 with a first tier of approval, due to the workflow requiring that approver 212 approve item 204 before approver 210. Further, AM process 20 may identify 128 an association of approver 212 with a second tier of approval, due to the workflow requiring that approver 212 approve item 206 after approver 214.

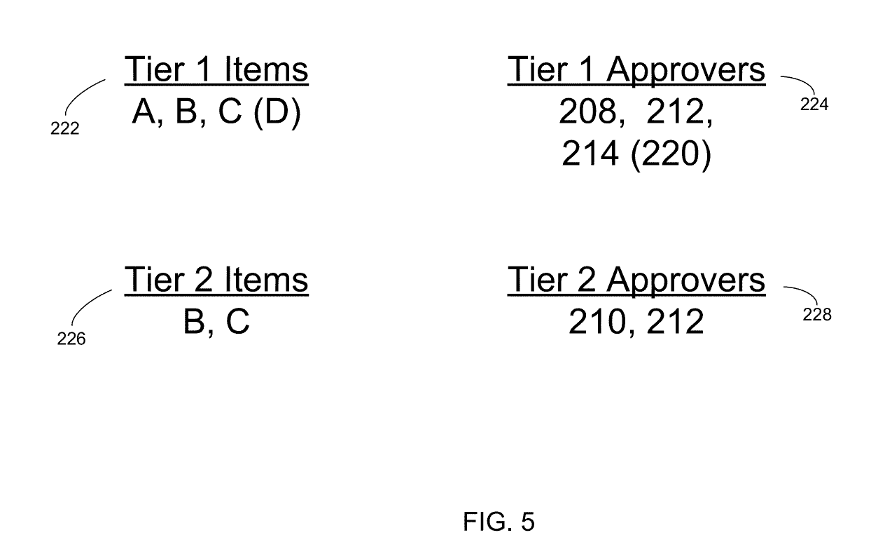

Referring now also to FIG. 5, and continuing the example above, items 202, 204, 206 (and 218, if added to project 200) may be associated with Tier 1 Items list 222 because approval of updates to these items is required from primary approvers. This association corresponds to approvers 208, 212, 214 (and 220, if item 218 is part of project 200) being associated with Tier 1 Approvers list 224. Similarly, item 204 and item 206 may be associated with Tier 2 Items list 226 because approval of updates to these items is required from secondary approvers. This association corresponds to approvers 210 and 212 beings associated with Tier 2 Approvers list 228. It will be noted that item 204 and item 206 are correspondingly associated with both Tier 1 Items list 222 and Tier 2 Items list 226 because approval of both of these items is required from both primary and secondary approvers. (It will be understood that these lists may be represented or stored in various ways, including as one or more records associated with a project workflow.)

As discussed above, it may not be efficient and/or desirable to require approver 212 to provide approval on multiple occasions, if this can be avoided. Accordingly, in one embodiment AM process 20 may determine that an alternate approver may approve item 204 as a primary approver and accordingly remove 130 approver 212 from Tier 1 Approvers list 224 (i.e., not request approval from approver 212 for item 204). In another embodiment, for example, AM process 20 may obtain 138 approval from approver 212 for both item 204 and item 206 after obtaining all (or some) other necessary first tier approvals (i.e., the approvals indicated by Tier 1 Approvers list 224 and Tier 1 Items list 222).

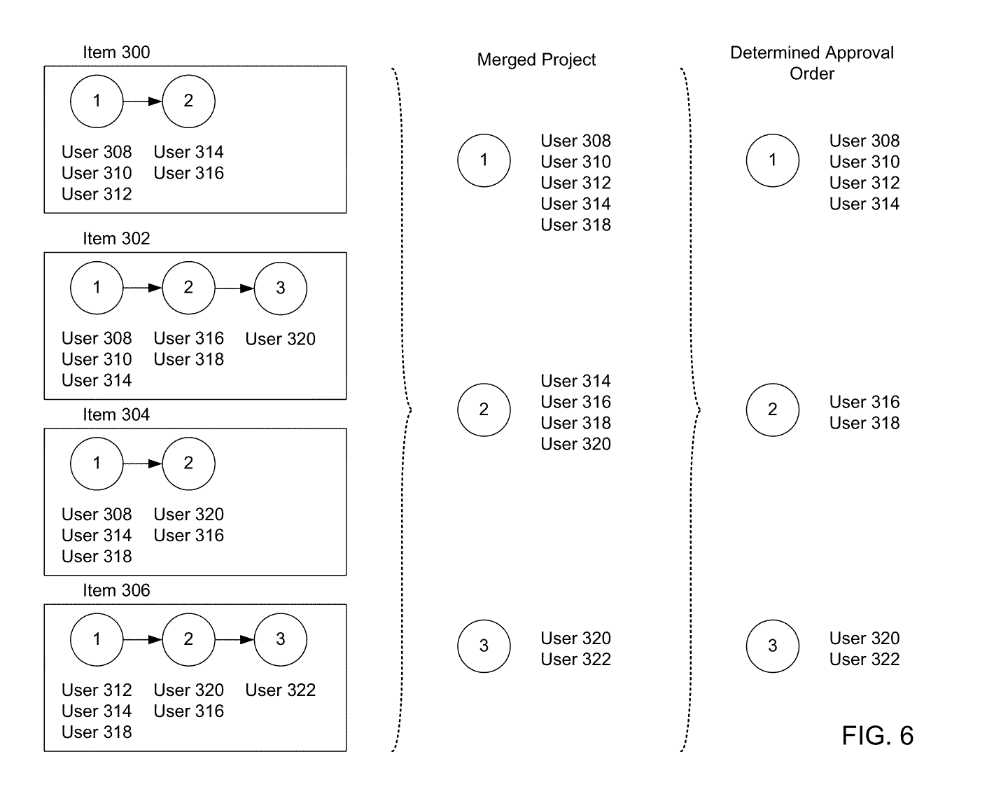

Referring now also to FIG. 6., a project may include items 300, 302, 304 and 306. Further, a tier of approval (indicated by numbered circles in FIG. 6) may associated with each item. For example, a first and second tier of approval may be associated with items 300 and 304, and a first, second and third tier may be associated with items 302 and 306. It will be understood that a third tier of approval may indicate the need for tertiary approval—i.e., approval dependent upon a secondary approval, which is itself dependent on a primary approval. For example, continuing the example above, a finance manager may provide a tier one (or primary) approval, followed by a vice president providing a tier two (or secondary) approval, followed by a president providing a tier three (or tertiary approval). In FIG. 6, approvers associated with each tier of approval for each respective document are indicated by the list of users below each tier. For example, for item 300, users 308, 310 and 312 are associated with a first tier of approval and users 314 and 316 are associated with a second tier of approval. Similarly, for item 302, users 318 and 316 are associated with a second tier of approval and user 320 is associated with a third tier of approval; for item 306 and, user 322 is associated with a third tier of approval; and so on.

Continuing the example of FIG. 6, when the project is considered as a whole (as indicated by the heading “Merged Project”) it is clear that users 308, 310, 312, 314 and 318 are associated with first-tier approval, that users 314, 316, 318 and 320 are associated with second-tier approval, and that users 320 and 322 are associated with third-tier approval. However, as also discussed above, it may be inefficient or otherwise undesirable to request approval from any given approver (i.e., any given “user”) on multiple occasions. Accordingly, it may be undesirable, for example, to keep user 314 associated with both the first and second tiers of approval. Therefore, as indicated by the heading “Determined Approval Order,” AM process 20 may remove 134 the association of user 314 with the second tier of approval and associate 136 with the first tier of approval all approvals associated with user 314 (i.e., approval of items 300, 302, 304 and 306). Additionally, in one embodiment, AM process may further obtain 138 all approvals associated with user 314 as part of the first tier of approval, but after obtaining all other approvals associated with the first tier of approval. Similarly, AM process may remove 130 the association of user 320 with the second tier of approval and associate 132 with the third tier of approval all approvals associated with user 320 (i.e., approval of items 302, 304, and 306). Additionally, in one embodiment, AM process may further obtain all approvals associated with user 320 as part of the third tier of approval, but before obtaining all other approvals associated with the third tier of approval.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of embodiments and implementations have been described. Nevertheless, it will be understood that various modifications may be made. Accordingly, other embodiments and implementations are within the scope of the following claims.

What is claimed is:

1. A computer-implemented method comprising:
identifying, by one or more computing devices, a project, the project including one or more items having an associated project workflow requiring approval of one or more portions of the project by one or more approvers;
identifying, by the one or more computing devices, a first update to a first item included in the project;
identifying, by the one or more computing devices, a first approver, wherein approval by the first approver of one or more of the first item and the first update to the first item is required by the project workflow;
associating, by the one or more computing devices, the first approver with the project based upon, at least in part, the approval by the first approver of one or more of the first item and the first update to the first item being required by the project workflow; and
determining, by the one or more computing devices, an order of approval for the project based upon, at least in part, identifying the first approver and identifying the first update to the first item.

2. The computer-implemented method of claim 1 further comprising:
identifying, by the one or more computing devices, an addition of a second item to the project;
identifying, by the one or more computing devices, a second approver, wherein approval by the second approver of one or more of the second item and a second update to the second item is required by the project workflow; and
associating, by the one or more computing devices, the second approver with the project based upon, at least in part, the approval by the second approver of one or more of the second item and the second update to the second item being required by the project workflow;
wherein determining the order of approval for the project is further based upon, at least in part, associating the second approver with the project.

3. The computer-implemented method of claim 1 further comprising:
identifying, by the one or more computing devices, an association of a third approver with the project, wherein approval by the third approver of a third item included in the project is required by the project workflow;
identifying, by the one or more computing devices, removal of the third item from the project;
determining, by the one or more computing devices, that the third approver is not associated with the approval of any item included in the project, other than the third item; and
removing, by the one or more computing devices, the association of the third approver with the project based upon, at least in part, at least one of identifying the removal of the third item from the project and determining that the third approver is not associated with approval of any item included in the project, other than the third item;
wherein determining the order of approval for the project is further based upon, at least in part, removing the association of the third approver with the project.

4. The computer-implemented method of claim 1 wherein determining the order of approval for the project further comprises:
determining, by the one or more computing devices, a first tier of approval and a second tier of approval;
identifying, by the one or more computing devices, an association of a duplicate approver with the first tier of approval and the second tier of approval;
removing, by the one or more computing devices, the association of the duplicate approver with the first tier of approval; and
associating with the second tier of approval, by the one or more computing devices, all approvals associated with the duplicate approver.

5. The computer-implemented method of claim 4 wherein the duplicate approver is associated with a secondary approval, the secondary approval depending from one or more primary approvals; and
wherein the determined order of approval includes obtaining the secondary approval from the duplicate approver after obtaining the one or more primary approvals.

6. The computer-implemented method of claim 1 further comprising:
determining, by the one or more computing devices, a first tier of approval and a second tier of approval;
identifying, by the one or more computing devices, an association of a duplicate approver with the first tier of approval and the second tier of approval;
removing, by the one or more computing devices, the association of the duplicate approver with the second tier of approval; and
associating with the first tier of approval, by the one or more computing devices, all approvals associated with the duplicate approver.

7. The computer-implemented method of claim 6 wherein the duplicate approver is associated with a secondary approval, the secondary approval depending from one or more primary approvals; and
wherein the determined order of approval includes obtaining the secondary approval from the duplicate approver after obtaining the one or more primary approvals.

8. The computer-implemented method of claim 6 further comprising:
obtaining, by the one or more computing devices, all approvals associated with the duplicate approver after obtaining each other approval associated with the first tier of approval.

9. A computer program product residing on a non-transitory computer-readable storage medium having a plurality of instructions stored thereon, which, when executed by a processor, cause the processor to perform operations comprising:
identifying a project, the project including one or more items and having an associated project workflow requiring approval of one or more portions of the project by one or more approvers;
identifying a first update to a first item included in the project;
identifying a first approver, wherein approval by the first approver of one or more of the first item and the first update to the first item is required by the project workflow;
associating the first approver with the project based upon, at least in part, the approval by the first approver of one or more of the first item and the first update to the first item being required by the project workflow; and
determining an order of approval for the project based upon, at least in part, identifying the first approver and identifying the first update to the first item.

10. The computer program product of claim 9 wherein the plurality of instructions, when executed by the processor, cause the processor to perform operations further comprising:
identifying an addition of a second item to the project;
identifying a second approver, wherein approval by the second approver of one or more of the second item and a second update to the second item is required by the project workflow; and
associating the second approver with the project based upon, at least in part, the approval by the second approver of one or more of the second item and the second update to the second item being required by the project workflow;
wherein determining the order of approval for the project is further based upon, at least in part, associating the second approver with the project.

11. The computer program product of claim 9 wherein the plurality of instructions, when executed by the processor, cause the processor to perform operations further comprising:
identifying an association of a third approver with the project, wherein approval by the third approver of a third item included in the project is required by the project workflow;
identifying removal of the third item from the project;
determining that the third approver is not associated with any item included in the project, other than the third item; and
removing the association of the third approver with the project based upon, at least in part, at least one of identifying the removal of the third item from the project and determining that the third approver is not associated with any item included in the project, other than the third item;
wherein determining the order of approval for the project is further based upon, at least in part, removing the association of the third approver with the project.

12. The computer program product of claim 9 wherein determining the order of approval for the project further comprises:
determining a first tier of approval and a second tier of approval;
identifying an association of a duplicate approver with the first tier of approval and the second tier of approval;
removing the association of the duplicate approver with the first tier of approval; and
associating with the second tier of approval all approvals associated with the duplicate approver.

13. The computer program product of claim 12 wherein the duplicate approver is associated with a secondary approval, the secondary approval depending from one or more primary approvals; and
wherein the determined order of approval includes obtaining the secondary approval from the duplicate approver after obtaining the one or more primary approvals.

14. The computer program product of claim 9 wherein the plurality of instructions, when executed by the processor, cause the processor to perform operations further comprising:
determining a first tier of approval and a second tier of approval;
identifying an association of a duplicate approver with the first tier of approval and the second tier of approval;
removing the association of the duplicate approver with the second tier of approval; and
associating with the first tier of approval all approvals associated with the duplicate approver.

15. The computer program product of claim 14 wherein the duplicate approver is associated with a secondary approval, the secondary approval depending from one or more primary approvals; and
wherein the determined order of approval includes obtaining the secondary approval from the duplicate approver after obtaining the one or more primary approvals.

16. The computer program product of claim 14 wherein the plurality of instructions, when executed by the processor, cause the processor to perform operations further comprising:
obtaining, by the one or more computing devices, all approvals associated with the duplicate approver after obtaining each other approval associated with the first tier of approval.

17. A computer system comprising:
at least one processor;
at least one memory architecture coupled with the at least one processor;
a first software module executable by the at least one processor and the at least one memory architecture, wherein the first software module is configured to identify a project, the project including one or more items and having an associated project workflow requiring approval of one or more portions of the project by one or more approvers;
a second software module executable by the at least one processor and the at least one memory architecture, wherein the second software module is configured to identify a first update to a first item included in the project;
a third software module executable by the at least one processor and the at least one memory architecture, wherein the third software module is configured to identify a first approver, wherein approval by the first approver of one or more of the first item and the first update to the first item is required by the project workflow;
a fourth software module executable by the at least one processor and the at least one memory architecture, wherein the fourth software module is configured to associate the first approver with the project based upon, at least in part, the approval by the first approver of one or more of the first item and the first update to the first item being required by the project workflow; and
a fifth software module executable by the at least one processor and the at least one memory architecture, wherein the fifth software module is configured to determine an order of approval for the project based upon, at least in part, identifying the first approver and identifying the first update to the first item.

18. The computer system of claim 17 further comprising:
a sixth software module executable by the at least one processor and the at least one memory architecture, wherein the sixth software module is configured to identify an addition of a second item to the project;
a seventh software module executable by the at least one processor and the at least one memory architecture, wherein the seventh software module is configured to identify a second approver, wherein approval by the second approver of one or more of the second item and a second update to the second item is required by the project workflow; and
an eighth software module executable by the at least one processor and the at least one memory architecture, wherein the eighth software module is configured to associate the second approver with the project based upon, at least in part, the approval by the second approver of one or more of the second item and the second update to the second item being required by the project workflow;
wherein determining the order of approval for the project is further based upon, at least in part, associating the second approver with the project.

19. The computer system of claim 17 further comprising:
a ninth software module executable by the at least one processor and the at least one memory architecture, wherein the ninth software module is configured to identify an association of a third approver with the project, wherein approval by the third approver of a third item included in the project is required by the project workflow;
a tenth software module executable by the at least one processor and the at least one memory architecture, wherein the tenth software module is configured to identify the removal of the third item from the project;
an eleventh software module executable by the at least one processor and the at least one memory architecture, wherein the eleventh software module is configured to determine that the third approver is not associated with any item included in the project, other than the third item; and
a twelfth software module executable by the at least one processor and the at least one memory architecture, wherein the twelfth software module is configured to remove the association of the third approver with the project based upon, at least in part, at least one of identifying the removal of the third item from the project and determining that the third approver is not associated with any item included in the project, other than the third item;
wherein determining the order of approval for the project is further based upon, at least in part, removing the association of the third approver with the project.

20. The computer system of claim 17 wherein determining the order of approval for the project further comprises:
determining a first tier of approval and a second tier of approval.
identifying an association of a duplicate approver with the first tier of approval and the second tier of approval;
removing the association of the duplicate approver with the first tier of approval; and
associating with the second tier of approval all approvals associated with the duplicate approver.

21. The computer system of claim 20 wherein the duplicate approver is associated with a secondary approval, the secondary approval depending from one or more primary approvals; and
wherein the determined order of approval includes obtaining the secondary approval from the duplicate approver after obtaining the one or more primary approvals.

22. The computer system of claim 17 further comprising:
a thirteenth software module executable by the at least one processor and the at least one memory architecture, wherein the thirteenth software module is configured to determine a first tier of approval and a second tier of approval;
a fourteenth software module executable by the at least one processor and the at least one memory architecture, wherein the fourteenth software module is configured to identify an association of a duplicate approver with the first tier of approval and the second tier of approval;
a fifteenth software module executable by the at least one processor and the at least one memory architecture, wherein the fifteenth software module is configured to remove the association of the duplicate approver with the second tier of approval; and
a sixteenth software module executable by the at least one processor and the at least one memory architecture, wherein the sixteenth software module is configured to associate with the first tier of approval all approvals associated with the duplicate approver.

23. The computer system of claim 22 wherein the duplicate approver is associated with a secondary approval, the secondary approval depending from one or more primary approvals; and
wherein the determined order of approval includes obtaining the secondary approval from the duplicate approver after obtaining the one or more primary approvals.

24. The computer system of claim 22 further comprising:
a seventeenth software module executable by the at least one processor and the at least one memory architecture, wherein the seventeenth software module is configured to obtain, by the one or more computing devices, all approvals associated with the duplicate approver after obtaining each other approval associated with the first tier of approval.

25. A computer-implemented method comprising:
identifying, by one or more computing devices, a project, the project including one or more items and having an associated project workflow requiring approval of one or more portions of the project by one or more approvers;
identifying, by the one or more computing devices a first update to a first item included in the project;
identifying, by the one or more computing devices, a first approver, wherein approval by the first approver of one or more of the first item and the first update to the first item is required by the project workflow;
associating, by the one or more computing devices, the first approver with the project based upon, at least in part, the approval by the first approver of one or more of the first item and the first update to the first item being required by the project workflow;
identifying, by the one or more computing devices, an addition of a second item to the project;
identifying, by the one or more computing devices, a second approver, wherein approval by the second approver of one or more of the second item and a second update to the second item is required by the project workflow;
associating, by the one or more computing devices, the second approver with the project based upon, at least in part, the approval by the second approver of one or more of the second item and the second update to the second item being required by the project workflow; and
determining, by the one or more computing devices, an order of approval for the project based upon, at least in part, identifying the first approver and associating the second approver with the project.
